(19) United States
(12) Patent Application Publication
(10) Pub. No.: US 2026/0181342 A1
(43) Pub. Date: Jun. 25, 2026

(54) METHODS AND SYSTEMS FOR TAMPERING DETECTION OF A MICROPHONE DEVICE

(71) Applicant: Axis AB, Lund (SE)

(72) Inventors: Peder SANDBERG, Lund (SE); Jonas ÅSTRÖM, Lund (SE)

(73) Assignee: Axis AB, Lund (SE)

(21) Appl. No.: 19/414,602

(22) Filed: Dec. 10, 2025

(30) Foreign Application Priority Data
Dec. 23, 2024 (EP) 24222904.5

(51) Int. Cl. H04R 29/00

(52) U.S. Cl. CPC H04R 29/004; H04R 2430/01

(57) ABSTRACT

A computer-implemented method for tampering detection of a microphone device, the microphone device comprising a microphone arranged in a cavity open to surroundings of the microphone device via a microphone hole, the method comprising: receiving an audio signal from the microphone; sampling the audio signal for a low frequency band; detecting an event comprising an exponentially decreasing absolute amplitude of the sampled audio signal during a time period of at least one second; and when detecting the event, outputting a tampering detection signal.

### FIELD OF THE INVENTION

The present disclosure relates to detection of tampering with microphones of microphone devices. More specifically, the present disclosure relates to detection of tampering that prevents a microphone from capturing sound accurately.

### BACKGROUND ART

Devices comprising microphones often consist of a microphone housed within a cavity open to an exterior of the device. However, sound may then be blocked from reaching the microphone in the channel by covering or sealing the opening of the channel. If the seal is tight, sound will not enter, hence rendering the microphone inoperative.

When the microphone is used as an audio sensor, where the sound is analysed by an algorithm, it is difficult to determine if the microphone of the device is tampered with without physically inspecting the device.

In such cases, the entire function of the microphone can be disabled without detection, compromising integrity of audio data being collected.

This underscores the need for more reliable ways to detect tampering of devices comprising microphones, ensuring that any interference, such as muffling or blocking, can be identified and addressed. Consequently, improvements in tampering detection are needed to maintain continuous and reliable audio monitoring.

### SUMMARY OF THE INVENTION

An objective of the present disclosure is to enable reliable detection of tampering with microphone devices.

Another objective is to improve the reliability and integrity of audio monitoring systems without the need for human intervention, such as manual listening or physical inspections.

A further objective is to facilitate automated analysis of audio signals, allowing for accurate identification of tampering with reduced false positives.

To achieve at least one of the above objectives and also other objectives that will be evident from the following description, a method having the features defined in claim 1 is provided according to the present invention. Preferred embodiments will be evident from the dependent claims.

More specifically, there is provided according to a first aspect of the present invention a computer-implemented method for tampering detection of a microphone device, the microphone device comprising a microphone arranged in a cavity open to surroundings of the microphone device via a microphone hole, the method comprising: receiving an audio signal from the microphone; sampling the audio signal for a low frequency band; detecting an event comprising an exponentially decreasing absolute amplitude of the sampled audio signal during a time period of at least one second; and when detecting the event, outputting a tampering detection signal.

Hereby, the method can detect tampering of a microphone device in a reliable manner. Consequently, reliability of audio monitoring systems can be improved.

This ensures that any interference, such as muffling or blocking of the microphone, can be quickly identified and addressed.

Generally, the method enables detection of sound blockage. Thus, allowing for identification of when the microphone is being deliberately obstructed, ensuring that any attempts to disable the microphone by blocking sound are reliably detected.

Further, the method enables the detection of tampering without the need for human intervention. For example, there may be no need for an individual to listen to audio recorded by the microphone device, nor is there a need for physical inspections of the microphone device to identify the tampering. This eliminates the need for manual work in identifying disabling or tampering of microphone devices. Hereby, the method enables more efficient and less labour-intensive identification of tampering with a microphone device.

In other words, the method enables the audio signal to be analysed by an algorithm, and to still allow for reliable identification of tampering. Hence, reliable automated tampering detection and analysis of the audio signal may be provided.

In addition, the method enables improved tampering detection without a need for any changes in hardware of the microphone device or microphone.

Furthermore, the method mitigates risks for detection of false positives. By detecting the characteristic event (comprising an exponentially decreasing absolute amplitude of the sampled audio signal during a time period of at least one second), the method can distinguish between definite tampering and other anomalies.

Hence, the method provides a robust and efficient solution for detecting tampering with microphone devices. By enabling reliable detection of sound blockage and tampering without the need for human intervention, the method enhances the reliability and effectiveness of audio monitoring systems.

The term “exponentially decreasing absolute amplitude” may refer to a specific pattern of amplitude reduction in the sampled audio signal. In this context, “exponential” means that a rate of decrease is proportional to a present amplitude, resulting in a relatively rapid initial decline that slows over time. Mathematically, this can be described by an exponential function, where the derivative of the amplitude with respect to time is linearly proportional to the amplitude itself, leading to a smooth and continuous decay towards a zero state of the sampled audio signal.

The exponentially decreasing absolute amplitude may be referred to as a ramp in the sampled audio signal. The ramp may approach a zero state of the sampled audio signal over time.

The ramp may be defined by an (absolute) exponential decay, where the amplitude diminishes at a rate proportional to its present value, leading to an initial decrease that gradually slows as it nears zero. The inclusion of absolute amplitude (i.e., amplitude magnitude) ensures that both positive and negative values of the audio signal are considered. The term “tampering” as used herein may refer to any attempts to disable or interfere with a microphone device's ability to record audio from its surroundings. Tampering may involve placing or attaching an object, such as chewing gum, cloth, tape, a hand, or any other item, over the microphone hole of the cavity in which the microphone is arranged. The action of tampering may be any act intended to cover or block the microphone by covering the microphone hole. Additionally, tampering can include any method that disrupts the microphone's functionality, such as applying substances that muffle sound.

The tampering detection signal may be outputted or presented to alert a user or supervisory personnel of audio monitoring systems comprising a microphone device. The tampering detection signal may, e.g., be outputted in forms including, but not limited to, audible alarms, digital messages such as error messages, text messages displayed on screens, visual alarms such as flashing lights, or digital notifications such as alerts in software applications,

The microphone device may be a device (e.g., camera, surveillance camera, mobile phone, wearable device, etc.) comprising a microphone. In particular, the microphone device may be any suitable device comprising a microphone housed or arranged in a cavity open to the surroundings of the microphone device via a microphone hole.

The microphone hole may be referred to as an opening of the cavity. Generally, the cavity may be a microphone compartment, or a microphone channel configured to house a microphone.

The microphone hole may be the only opening of the cavity. Hence, there may be no connection, hole, or opening between the cavity and an interior of the microphone device. In other words, the cavity may form a closed compartment that is only open to the surroundings of the microphone device.

The term “audio signal” as used herein may refer to an electrical representation of sound. This includes digital signals, which are discrete representations of sound created by sampling an analog signal at regular intervals. The audio signal can be generated by the microphone when it captures sound from its surroundings or environment, converting acoustic energy into an electrical signal that can be processed, transmitted, or recorded. The audio signal may contain information about the amplitude, frequency, and/or phase of the sound. The audio signal may, e.g., be represented by a movement (i.e., displacement) of a membrane of the microphone. The audio signal may be represented in an amplitude-over-time graph, e.g., where the movement of the microphone membrane corresponds to an amplitude of the audio signal.

It is further to be understood that the term “absolute amplitude” refers to absolute values of the amplitude.

In general terms, a microphone functions as a transducer that converts sound (pressure) into an electrical current. It comprises a membrane that vibrates in response to sound waves. The resulting electrical signal from the microphone corresponds to the position of the membrane at each moment in time. When an object is pressed against the microphone hole, the movement of the membrane is impeded, leading to a reduction or complete cessation of the audio signal.

As the object is pressed against the microphone hole, a pressure change (e.g., pressure increase) occurs in the cavity. This change in pressure causes the membrane of the microphone to move in a characteristic manner. The resulting movement (i.e., high absolute amplitude while having a low frequency) of the microphone membrane differs from membrane movements resulting from normal or conventional sound.

Specifically, when something is pressed against the microphone hole, the microphone membrane is displaced in relatively large and slow movements. The membrane consequently exhibits a DC offset, i.e., a displacement from its neutral position, resulting from the change in pressure in the cavity. However, the membrane will eventually return to DC (i.e., a center position). Notably, this return of the membrane is relatively slow and follows an exponential behavior.

The method described herein involves detecting an event comprising the above-described behavior of the audio signal (i.e., behavior of the membrane of the microphone). This enables reliable detection of tampering with the microphone device, e.g., corresponding to covering the microphone hole.

The process of sampling the audio signal for a low-frequency band may comprise decimating the audio signal to a sampling rate of approximately 200 Hz. This decimation process may be performed in multiple stages. Initially, the audio signal may be downsampled by a factor of 2, effectively halving the sampling rate. This step may be followed by another downsampling stage by a factor of 3, reducing the sampling rate to one-third of its previous value. These stages may be carried out in accordance with established signal processing techniques. To maintain the integrity of the audio signal, an additional low-noise low-pass filter may be applied between the final decimation stages. This filter may be of a Scaled Normal Form (SNF) type, which may be designed to minimize noise and preserve the quality of the audio signal during the decimation process.

Generally, the low frequency band may comprise frequencies below 500 Hz. However, it is appreciated that the low frequency band may, e.g., comprise frequencies below 1 kHz, preferably below 500 Hz, or more preferably below, 250 Hz.

The low frequency band may be implemented using a low pass filter. The low pass filter may be designed to detect and process frequencies within a specified range, such as approximately 0.1 Hz to 500 Hz. In an example, the low pass filter may sample frequencies below 250 Hz or below 200 Hz.

Hereby, low-frequency audio signals may pass through while higher-frequency noise may be attenuated. This may facilitate detection of the event in the audio signal.

Further, by improving the signal-to-noise ratio, the low-pass filter may make the audio signal cleaner and more reliable for further processing or analysis to detect the event.

In a sense, the audio signal from the microphone may be downsampled as the event occurs at low frequencies.

The time period during which the exponentially decreasing absolute amplitude of the event decreases exponentially may be 1-20 seconds.

In other words, it may take 1-20 seconds for the membrane of the microphone to reach or return to DC. Hence, when the absolute amplitude decreases, the amplitude of the sampled audio signal approaches DC (i.e., corresponding to a rest state, or zero state, of the membrane).

In an example, the time period may be 2-10 seconds. However, it is appreciated that the time period of the exponentially decreasing absolute amplitude may be a characteristic for different microphone types or different microphone devices. The time period may, e.g., depend on a size of the microphone, cavity, and/or microphone hole. Hence, the time period may be a known or predetermined value for a specific type of microphone device.

Hereby, enhanced reliability in the detection of the event may be provided. For example, it may be facilitated to further rule out false positives.

In an example, the event may comprise an absolute amplitude peak of the sampled audio signal followed by an exponentially decreasing absolute amplitude of the sampled audio signal during a time period of at least one second.

The step of detecting the event may further comprise detecting an absolute amplitude peak of the sampled audio signal before the exponentially decreasing absolute amplitude of the sampled audio signal.

The absolute amplitude peak may be detected just before the exponentially decreasing absolute amplitude, e.g., within 3 or 5 seconds before the exponentially decreasing absolute amplitude.

The sampled audio signal may be continuously monitored using a peak detection algorithm. The peak detection algorithm may be a conventional algorithm for identifying (absolute) peaks in a signal, e.g., by comparing the amplitude of the sampled audio signal with a predefined threshold value. The threshold value may represents a normal or expected sound level. When the amplitude of the sampled audio signal exceeds the threshold, the absolute amplitude peak is identified as a peak. The peak detection algorithm may record the occurrence of the peak, including its amplitude and the time at which it occurs. This may ensure that (absolute) amplitude peaks are accurately detected and logged. The peak may be used as a criterion for detecting the event in the sampled audio signal, which hence may comprise two distinct behaviors (i.e., the amplitude peak followed by the exponential behavior).

The absolute amplitude peak may be at least an order of magnitude higher than absolute amplitudes of the sampled audio signal caused by background noise of the surroundings. However, the absolute amplitude peak of the event may, e.g., be at least 20 times higher or two orders of magnitude higher than the absolute amplitudes in the sampled audio signal resulting from normal or conventional sounds. Normal or conventional sounds may here refer to audio signals that adhere to standard acoustic properties or (statistically) typical amplitude ranges.

Hence, facilitated detection of the event may be provided, e.g., since the absolute amplitude peak of the event may be substantially higher (and thus more distinguishable or distinct) compared to other absolute amplitudes of the sampled audio signal.

The time period may start at least one second after detecting the absolute amplitude peak.

In other words, the method may comprise waiting at least one second after detecting the absolute amplitude peak and/or before performing the step of detecting the event. Hence, certain audio signal behaviors may be excluded from analysis.

In an example, the method may comprise waiting a maximum of three seconds after detecting the absolute amplitude peak, before detecting the event. Phrased differently, the time period may start at most three seconds after the detection of the absolute amplitude peak.

An instantaneous rate of change of the exponentially decreasing absolute amplitude may be linearly proportional to a corresponding instantaneous amplitude of the sampled audio signal.

In other words, a slope of an amplitude-time curve representing the sampled audio signal, may be linearly proportional to the amplitude of the sampled audio signal during the exponential decrease of the absolute amplitude. This may hold for each point in time during said exponential decrease.

The linear proportionality between the slope and amplitude may be a characteristic of the event. Specifically, the linear proportionality between the slope and amplitude may be a characteristic of the of the exponentially decreasing absolute amplitude.

Hence, more precise detection of the event within the sampled audio signal may be provided, enabling faster and more accurate detection of tampering with the microphone device.

The step of detecting the event may comprise, segmenting the sampled audio signal into a plurality of time slots; and within each time slot: fitting a linear model (i.e., applying a linear regression) to capture a local trend, determining a mean amplitude value of the linear model, determining a slope of the linear model, and determining a fit quality metric of the linear model, such that each time slot is represented by a matrix comprising a mean amplitude value, a slope, and a fit quality metric.

In other words, the method may comprise smoothing the sampled audio signal.

By representing each time slot with a matrix as described above, the sampled audio signal may be represented as a series of values of mean amplitude, slope, and fit quality metric.

In a sense, the sampled audio signal may be split into timeslots, wherein the sampled audio signal in each time slot is modeled using a linear regression approach (where the sampled audio signal in each time slot is estimated to fit a linear equation). For the linear fit in each time slot, an average amplitude value, a slope, and a quality metric of the fit, can be determined.

The linear model may, e.g., be based on a Theil-Sen-Kendall-Siegel approach, a least squares regression, a least absolute deviations regression, a ridge regression, a robust regression, or a lasso regression.

The fit quality metric may serve as an indicator of the extent to which the sampled audio signal within the time slot exhibits linear behavior. The fit quality metric may be referred to as a goodness-of-fit metric.

The fit quality metric may, e.g., be a value of R2, adjusted R2, RMSE, MAE, AIC, BIC, or any other suitable metrics for representing goodness or quality of a fit. The fit quality metric may, e.g., be between 0-1, where 1 may represent a perfect fit.

The method may comprise, within each time slot, first fitting a linear model, and subsequently using a statistical measure, such as residual sum of squares, to evaluate a deviation of each data point (i.e., amplitude) from the fitted linear model. Data points that deviate from a local trend, e.g., beyond a predetermined threshold, may be considered outliers. The outliers may then be excluded from the regression analysis within each time slot.

Hence, the smoothing may be performed by using local linear smoothing with block-trimmed least squares regression.

Such a trimming process may ensure that the linear regression is not unduly influenced by extreme values, leading to a more reliable and accurate representation of underlying local trends in the sampled audio signal.

The fitting of the linear model may, e.g., be an adaptively trimmed least-squares model. This may comprise adjusting the fitting process to minimize influence of outliers and provide a more robust regression.

The step of detecting the event may further comprise determining, for a consecutive sequence of time slots, if the fit quality metrics are above a threshold value for at least a portion of the time slots in the consecutive sequence of time slots.

In other words, it may be determined if the sampled audio signal (i.e., amplitude), within each time slot of the at least portion of time slots, resembles a linear line. Hence, if the fit quality metrics are not above the threshold value for at least the portion of the time slots in the consecutive sequence of time slots, it may be determined that the event is not detected.

In an example, the threshold value may be set to at least 0.7 on a scale of 0-1, where 1 represents a perfect fit.

The portion of time slots may, e.g., be at least 20%, or at least 10-30% of the time slots in the consecutive sequence of time slots.

The consecutive sequence of time slots may, e.g., correspond to 5 -15 seconds, or about 10 seconds.

For example, if sampled the audio signal resembles a linear line (i.e., have a sufficiently high fit quality metric) in at least 20% of the time slots in a 10 second interval, it may be indicative of the event having occurred.

Generally, adding a criterion that at least a subset of the fit quality metrics should exceed a threshold, aids in identifying the presence of a local linear trend. By setting a threshold, it may be facilitated to filter out noise and irrelevant portions or snippets of the sampled audio signal. This can lead to more robust detection of the event in the sampled audio signal.

The step of detecting the event may further comprise: identifying an interval of time slots having a highest numerical sum of fit quality metrics in the plurality of time slots; and determining, for the interval of time slots, a score representing a likelihood of the event having occurred in the sampled audio signal in the interval of time slots.

The interval of time slots corresponding to the highest (i.e., maximum) numerical sum of fit quality metrics may represent a majority of the time slots, e.g., around 70-80% or approximately 75%.

The interval of time slots may be determined from the consecutive sequence of time slots. The interval of time slots may, e.g., be determined by selecting the top 70% of time slots with the highest fit quality metrics within the consecutive sequence of time slots. For example, the time slots (or matrices corresponding to the time slots) can be sorted by their fit quality metrics, such that the bottom 30% with the lowest fit quality metrics (i.e., poorest fits) can be excluded from further processing.

This allows for exclusion of irrelevant data or data unlikely to correspond to the event, thereby enabling more reliable event detection.

The score may be determined based on a plurality of sub-scores, each sub-score corresponding to a respective sub-interval of time slots within the interval of time slots.

In other words, the interval of time slots may be split into a plurality of sub-intervals such that a score may be determined for each sub-interval. The sub-intervals may be non-overlapping and/or sequentially shifted over the interval.

The size of the sub-intervals may be arbitrary and/or fixedly chosen. For example, the interval of time slots may be split into two or more sub-intervals.

An overall (i.e., final) score may hence be determined based on the scores (i.e., sub-scores) from the sub-intervals, e.g., by a median or mean value.

Hereby, a more granular analysis of the sampled audio signal may be provided, e.g., capturing variations within smaller segments that might be overlooked in a broader analysis. By evaluating sub-scores for each sub-interval, the method may detect localized patterns and anomalies (i.e., the event) more effectively.

Hence, a more reliable overall score may be provided for indicating the occurrence of the event.

The step of detecting the event may further comprise determining a linear regression with the slope of the linear model of each time slot in the interval of time slots as a function of the mean amplitude value the linear model of each time slot in the interval of time slots, such that, k=c₁+m*c₀, where k is the slope of the linear model in each time slot, m is the mean amplitude value of the linear model in each time slot, and c₁ and c₀ are constants.

Hence, based on the values of the slopes and mean amplitudes in the time slots (i.e., in the matrices corresponding to the time slots), a linear relation between these values may be determined.

The linear relation between the mean amplitude and slope over the time slots may be a characteristic of the event. Hence, by determining the presence of said linear relation, it may be determined that the event has occurred in sampled the audio signal.

The linear regression may be referred to as a final linear regression or a k-m linear regression, e.g., to distinguishing it from the linear models fitted within the time slots. However, the linear regression may benefit from the same discussion as the linear model fitted within each the time slot.

The linear regression may, e.g., be based on a Theil-Sen-Kendall-Siegel approach, a least squares regression, a least absolute deviations regression, a ridge regression, a robust regression, or a lasso regression.

In an example, the linear regression may be determined with the slope of the linear model of each time slot (e.g., for all time slots or in the consecutive sequence of time slots) as a function of the mean amplitude value the linear model of each time slot (similarly, e.g., for all time slots or in the consecutive sequence of time slots).

The score may be represented by a quality of fit metric of the determined linear regression k=c₁+m*c₀.

The quality of fit metric for the linear regression may be referred to as a final quality of fit metric or a k-m quality of fit metric, e.g., to distinguish the quality of fit metric of the k-m linear regression from the fit quality metric of the linear models of in the time slots. However, the k-m quality of fit metric may benefit from the same discussion as the fit quality metric of the linear models in the time slots.

The score may be compared against a fixed threshold value. The fixed threshold may, e.g., be set to at least 0.7 on a scale of 0-1, where 1 represents a perfect fit.

In an example, a threshold of 0.7 may result in no false triggers for over 20,000 million 10-second-long simulated signals.

Hence, when the score is above the fixed threshold value (i.e., when the k-m linear regression results in a sufficiently high k-m quality of fit metric) it may be determined that the event has occurred in the sampled audio signal.

The score may be determined by a score function. In an example when the interval of time slots is split into a plurality of sub-intervals, the score may, e.g., be determined as,

i. score=F(Q_{SLR} of SLR([k=c*m] over <all time slots in the sub-intervals of time slots>)),
where SLR is a simple linear regression (i.e., the k-m linear regression) of the slope k and mean amplitude m for each time slot in the sub-intervals of time slots, Q_{SLR} is a quality of fit metric of the SLR for each sub-interval, and F is a mean value or median-like function.

In other words, the score may be represented by a value (e.g., median, mean, etc.) of the quality of fit metrics (i.e., sub-scores) of the k-m linear regressions of the sub-intervals of time slots. In a sense, the score may be given by score=F(sub-scores), i.e., a median or mean value of the sub-scores of each sub-intervals.

The score may, for example, be defined as a second to biggest value of the k-m quality of fit metrics in the sub-intervals.

If no score or sub-score is found, the score may be set to 0.

The computer-implemented method may further comprise performing a validation step comprising: determining if c₀ corresponds to a zero state of the sampled audio signal, and determining if c₁ corresponds to an expected time period during which the exponentially decreasing absolute amplitude of the event decrease exponentially.

Hence, when c₀ does not correspond to the zero state of the sampled audio signal (i.e., DC of the microphone), and/or when c₁ does not correspond to the expected time period during which the exponentially decreasing amplitude of the event decrease exponentially, it may be determined that the event has not occurred.

The constant c₀ may, e.g., preferably match or correspond to the zero state (i.e., sampled audio signal DC) over at least the past 60 seconds.

The expected time period may be a known or predefined time period. In particular, the expected time period may be a characteristic feature of different types of microphones or different types of microphone device. The expected time period may, e.g., be determined from experiments or a look-up table.

According to a second aspect, there is provided a non-transitory computer-readable medium storing instructions thereon which, when executed by a processor, cause the processor to carry out the steps of the method according to the first aspect.

This aspect may generally present the same or corresponding advantages as the first aspect.

According to a third aspect, there is provided a system comprising: a microphone device comprising a microphone arranged in a cavity open to surroundings of the microphone device via a microphone hole; and a processing unit configured to execute the method according to the first aspect.

This aspect may generally present the same or corresponding advantages as the first aspect.

The processing unit may be configured to receive an audio signal from a microphone device and perform various processing tasks and extract relevant information. Upon receiving an analogue audio signal, the processing unit may digitize the analogue audio signal.

The processing unit may analyse the audio signal to detect or isolate specific audio features, such as the event. The processing unit may employ filtering techniques to remove unwanted frequencies and enhance desired audio components, such as low frequency components.

The processing unit may, e.g., be a microprocessor, digital signal processor (DSP), application-specific integrated circuit (ASIC), or a field-programmable gate array (FPGA).

Further, the processing unit may be communicatively connected to a plurality of microphone devices, e.g., a network of microphone devices. Hence, the processing unit may simultaneously detect or monitor tampering of a plurality of microphone devices.

The processing unit may be remote from the microphone device. However, it is appreciated that the processing unit may be integrated into the microphone device.

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of said element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 shows a diagram of a computer-implemented method for tampering detection of a microphone device.

FIGS. 2A-B schematically illustrates microphone devices comprising a microphone in a cavity.

FIG. 3 schematically illustrates a system comprising a microphone device and a processing unit.

FIG. 4A illustrates an exemplary audio signal comprising an event corresponding to tampering of a microphone device.

FIG. 4B illustrates another exemplary audio signal comprising an event corresponding to tampering of a microphone device.

FIG. 4C illustrates an exemplary audio signal comprising a plurality of events corresponding to tampering of a microphone device.

### DESCRIPTION OF EMBODIMENTS

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

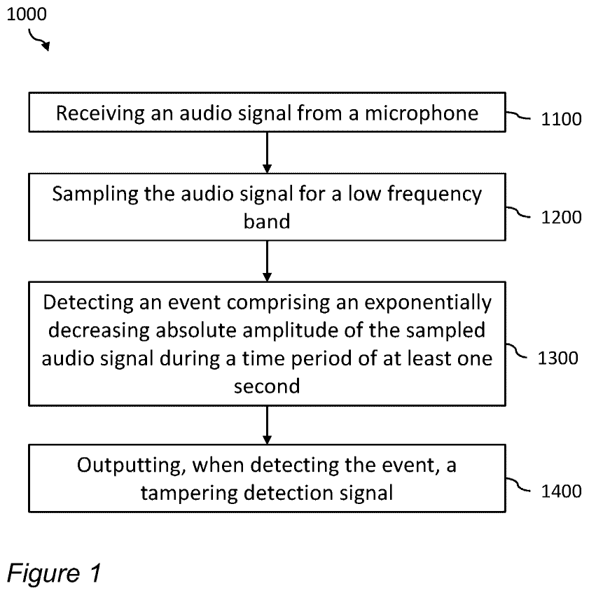

FIG. 1 shows a block diagram of a computer-implemented method 1000 for tampering detection of a microphone device 100. The method 1000 comprises:
i. receiving 1100 an audio signal 112 from the microphone 110;
ii. sampling 1200 the audio signal 112 for a low frequency band;
iii. detecting 1300 an event 140 comprising an exponentially decreasing absolute amplitude of the sampled audio signal 130 during a time period of at least one second; and
iv. when detecting the event 140, outputting 1400 a tampering detection signal.

Although not shown on FIG. 1, the step of detecting 1300 the event 140 may comprise segmenting the sampled audio signal 130 into a plurality of time slots; and within each time slot: fitting a linear model to capture a local trend, determining a mean amplitude value of the linear model, determining a slope of the linear model, and determining a fit quality metric of the linear model, such that each time slot is represented by a matrix comprising a mean amplitude value, a slope, and a fit quality metric.

Further, the step of detecting 1300 the event may comprise: determining, for a consecutive sequence of time slots, if the fit quality metrics are above a threshold value for at least a portion of the time slots in the consecutive sequence of time slots.

The step of detecting 1300 the event 140 may further comprise: identifying an interval of time slots having a highest numerical sum of fit quality metrics in the plurality of time slots; and determining, for the interval of time slots, a score representing a likelihood of the event 140 having occurred in the sampled audio signal 130 in the interval of time slots.

In yet another example not depicted in FIG. 1, the step of detecting 1300 the event 140 may comprise: determining a linear regression with the slope of the linear model of each time slot in the interval of time slots as a function of the mean amplitude value the linear model of each time slot in the interval of time slots, such that, k=c₁+m*c₀, where k is the slope of the linear model in each time slot, m is the mean amplitude value of the linear model in each time slot, and c₁ and c₀ are constants.

It is appreciated that the score may be determined based on a plurality of sub-scores, each sub-score corresponding to a respective sub-interval of time slots within the interval of time slots. In a particular example, the score may be represented by a quality of fit metric of the determined linear regression k=c₁+m*c₀.

Furthermore, although not shown in FIG. 1, the method 1000 may further comprise performing a validation step comprising: determining if c₀ corresponds to a zero state 132 of the sampled audio signal 130, and determining if c₁ corresponds to an expected time period during which the exponentially decreasing absolute amplitude of the event decrease exponentially.

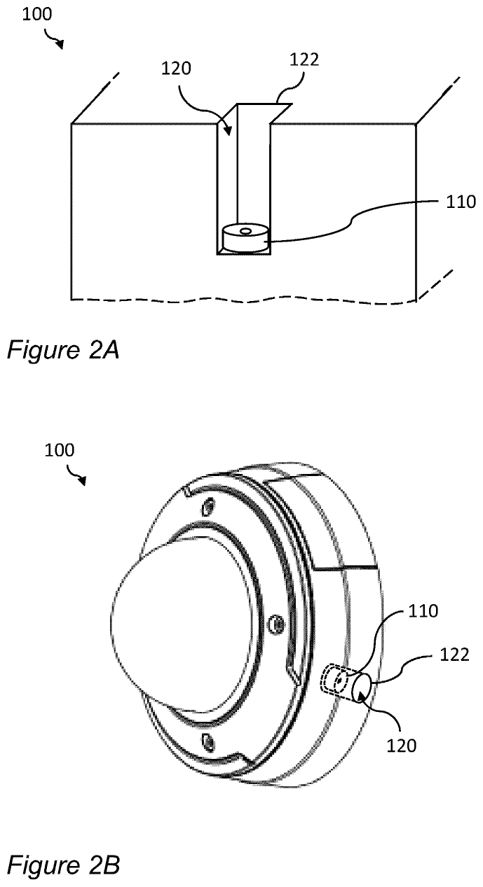

FIG. 2A illustrates a partial cross-section of a microphone device 100. The microphone device 100 comprises a microphone 110 arranged in a cavity 120 of the microphone device 100. The cavity 120 is open to the surroundings of the microphone device 110 via a microphone hole 122.

Notably, the microphone hole 122 is the only opening of the cavity 120. Hence, the microphone 110 is placed in a cavity 120 that is acoustically isolated from the rest of the microphone device 100. The microphone 110 can thus effectively capture sound from its surroundings while mitigating interference from internal components.

Generally, the placement of the microphone 110 within the cavity 120 aids in protecting the microphone 110 from external environmental factors, such as dust and moisture.

Further, although not shown in the FIG. 2A, it is to be understood that the microphone 110 may be electrically connected to internal components of the microphone device 120.

Furthermore, it is appreciated that the microphone hole 122 (i.e., the opening of the cavity 120) may comprise a mesh or a protective net or layer. This may mitigate dust and debris from entering the cavity 120, thereby protecting the microphone 110 and still enabling clear audio capture.

FIG. 2B illustrates a microphone device 100 in the form of a camera device. Similarly as described in relation to FIG. 2A, the microphone 110 is integrated in the camera device. As seen in FIG. 2B, the microphone 110 is arranged in a cavity 120 open to a surrounding via a microphone hole 122.

In a sense, the microphone 110 is embedded in a dedicated cavity 120 within a camera housing of the camera device, with an opening 122 to the exterior environment.

Although not shown in FIGS. 2A-B, the microphone device 100 may comprise a processor configured to execute a computer-implemented method for detecting tampering with the microphone device 110 (i.e., blocking of the microphone hole 122), e.g., as described in relation to FIG. 1.

It is further to be understood that the proportions, shapes, and relative scales in the drawings are exemplary and exaggerated to aid visualization. In a practical case, the microphone hole 122 may have a relatively small diameter, for example, about 1 mm. Similarly, the depth of the microphone hole may range from approximately 1 mm to 2 mm.

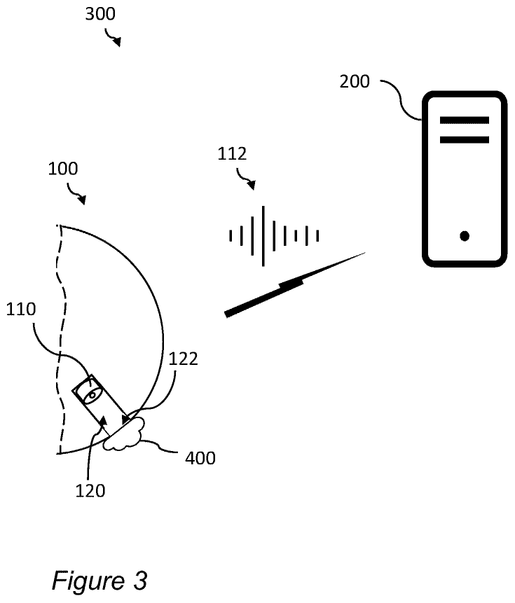

FIG. 3 illustrates a system 300 comprising: a microphone device 100 comprising a microphone 110 arranged in a cavity 120 open to surroundings of the microphone device 110 via a microphone hole 122; and a processing unit 200 configured to execute a computer-implemented method for detecting tampering with the microphone device 110, e.g., as described in relation to FIG. 1.

The microphone device 100 is here illustrated as a cross-section of the microphone device 100. The microphone device 100 may, e.g., be the microphone device as discussed in relation to any of FIGS. 2A-B.

Further in FIG. 3, the microphone hole 122 is covered by an object 400. The object 400 being placed on the microphone hole 122 of the cavity 120 may be analogous to tampering with the microphone device 100.

The object 400 may be any suitable object, e.g., a chewing gum, a cloth, tape, a hand, or the like which covers the microphone hole 122. The object 400 being arranged over the microphone hole 122 may generally correspond an act intended to block sound from reaching the microphone 110 of the microphone deice 100.

The object 400 may be pressed against the microphone hole 122 such that it closes off the cavity 120 from the surroundings, i.e., the object 400 may provide a tight seal to the cavity 120.

In FIG. 3, the processing unit 200 receives an audio signal 112 from a microphone device 100.

At the processing unit 200, the audio signal 112 may be received as an analogue audio signal. Hence, the processing unit 200 may be configured to digitizes the analogue audio signal.

The processing unit 200 may analyse the audio signal 112 to detect tampering with the microphone device 100 (i.e., detect the event of an exponentially decreasing absolute amplitude of the sampled audio signal 130 during a time period).

The processing unit 200 may employ filtering techniques to remove unwanted frequencies and enhance desired audio components, such as low frequency components. In particular, the processing unit 200 may comprise a low frequency band. The low frequency band may comprise frequencies below 500 Hz. However, it is appreciated that the low frequency band may be part of the microphone device 100 or the microphone 110.

The processing unit 200 may, e.g., be a microprocessor, digital signal processor (DSP), application-specific integrated circuit (ASIC), or a field-programmable gate array (FPGA). Generally, the processing unit 200 may be any suitable device having processing capabilities.

Further, although not explicitly depicted in FIG. 3, the processing unit 200 may be communicatively connected to a plurality of microphone devices 100, e.g., a network of microphone devices 100. In other words, the processing unit 200 may be configured to simultaneously analyse audio signals 130 from a plurality of microphone devices 100. The processing unit 200 (e.g., a single processing unit 200) may hence detect or monitor tampering of a plurality of microphone devices.

Furthermore, in FIG. 3, the processing unit 200 is depicted to be remote from the microphone device 100. However, the processing unit may, e.g., be integrated into the microphone device 100. In an example, a main microphone device in a network of microphone devices may comprise the processing unit 200 or possess processing capabilities. Hence, audio signals from other microphone devices in the network of microphone devices may be sent to the main microphone device for processing.

The system 300 may, e.g., be an audio monitoring system or form part of an audio monitoring system. The system may further comprise means for presenting an alert or indication to a user or supervisory personnel of audio monitoring systems when the microphone device has been tampered with (e.g., via a monitor).

Although not explicitly shown in FIG. 3, there may be provided a non-transitory computer-readable medium storing instructions thereon which, when executed by a processor (such as the processing unit 200), cause the processor to carry out the steps of a computer-implemented method for tampering detection of the microphone device 100, e.g., as described in relation to FIG. 1.

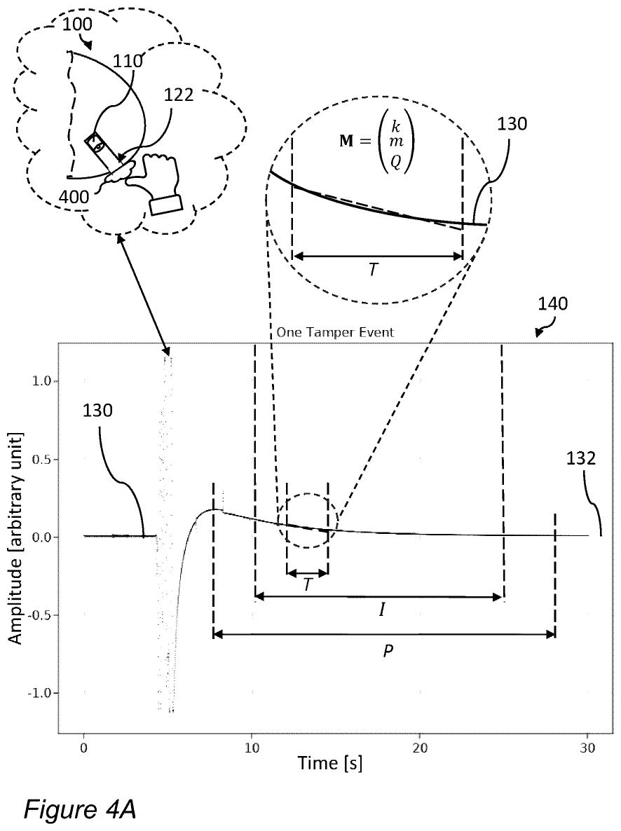

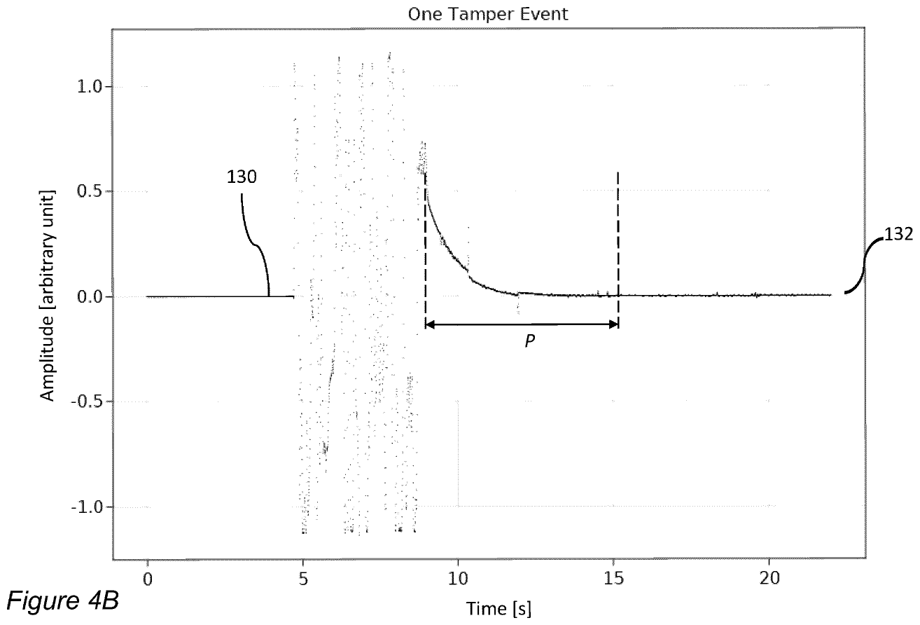

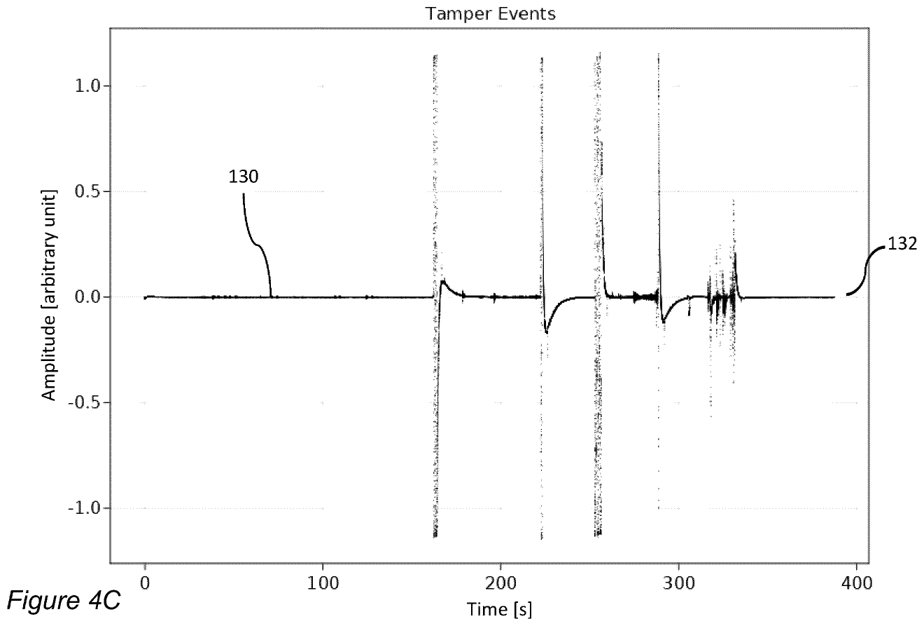

FIG. 4A shows an exemplary sampled audio signal 130 from a microphone device having been tampered with. The sampled audio signal 130 is here represented by an amplitude over time graph.

A first portion of the sampled audio signal 130 is seen to correspond to general audio characteristics or a typical behavior of an audio signal, e.g., corresponding to background noise.

In a second portion of the sampled audio signal 130, an amplitude peak is observed.

The amplitude peak may represent a maximum absolute amplitude value that the sampled audio signal 130 reaches in a portion of the sampled audio signal 130. In a sense, the absolute amplitude peak can be considered an absolute amplitude maxima.

However, in FIG. 4A, the amplitude peak also comprises negative values. Hence, the amplitude peak may be referred to as an absolute amplitude peak. Thus, also the trough or minimum amplitude values may be included in the absolute amplitude peak.

The (absolute) amplitude peak is substantially higher than the amplitude elsewhere on the sampled audio signal 130. Typically, the amplitude peak may be at least an order of magnitude higher than amplitudes of the sampled audio signal 130 caused by background noise from the surroundings.

In the specific audio signal 130 depicted in FIG. 4A, after the absolute amplitude peak (specifically after an amplitude minima), the sampled audio signal 130 increases towards the zero state 132 and surpasses the zero state 132. Thereafter, the sampled audio signal 130 reaches a local maxima.

Subsequent to this local maxima, the amplitude of the sampled audio signal 130 is observed to decrease in an exponential manner. The amplitude of the sampled audio signal 130 decreases in an exponential manner during a time period, P.

The time period, P, during which the exponentially decreasing amplitude decreases exponentially may typically be 1-20 seconds.

In FIG. 4A, the time period, P, starts about three seconds after the absolute amplitude peak. However, the time period, P, (i.e., the exponentially decreasing absolute amplitude) may start directly (as depicted in FIG. 4B) or at least one second after the absolute amplitude peak.

The amplitude peak and/or the exponentially decreasing amplitude (i.e., ramp) may be referred to as an event 140. The event 140 may be an indicative of tampering with the microphone device 100.

In the upper left inset of FIG. 4A, exemplary tampering of a microphone device 100 is schematically illustrated. Here, an object 400 is pressed against a microphone hole 122 of the microphone device to block sound from reaching a microphone 110 of the microphone device 100.

As illustrated in FIG. 4A, the act or occurrence of blocking the microphone hole 122 results in the event 140 in the sampled audio signal 130 being captured by the microphone 110.

From an act of pressing the object 400 against the microphone hole 122, minor movements or vibrations of the microphone device 100 caused by said act (e.g., minor tremors from a hand during the act) affects the amplitude of audio recorded by the microphone 110. Such movements or vibrations may cause the absolute amplitude peak to appear in the sampled audio signal 130. In particular, in cases of tampering, there may be higher frequency or amplitude values detected from touching of the microphone device 100.

The amplitude peak is thus here seen to comprise a plurality of amplitude peaks. The low resolution of the sampled audio signal at the amplitude peak is caused by the strong and rapid movements of the microphone membrane caused during the act of attaching the object 400 to the microphone device 100 (e.g., due to vibrations of the microphone device 100). The amplitude peak may hence be referred to as a root-mean-squared (RMS) peak (i.e., a peak of many peaks).

In this context the term “RMS peak” may be used to describe the effective amplitude of the sampled audio signal 130 that exhibits multiple peaks forming one larger peak. An RMS value may represent a measure of the sampled audio signal's 130 amplitude peak by calculating the square root of the mean of the squares of the instantaneous values over a specified period (i.e. over the many amplitude peaks caused by touching the microphone device 100).

Further, by covering the microphone hole 122, air is trapped in the cavity which cannot escape, or which will escape more slowly than before the microphone hole 122 was covered. These physical interactions (i.e., tampering) with the microphone device 100 may give rise to the event 140 in the sampled audio signal 130 recorded by the microphone device 100.

A characteristic of the event 140 may be that an instantaneous rate of change of the exponentially decreasing amplitude is linearly proportional to a corresponding instantaneous amplitude of the sampled audio signal 130.

In the upper right inset of FIG. 4A, an enlarged portion of sampled the audio signal 130 is depicted. In particular, the sampled audio signal 130 in time slot T is seen to be approximated by a linear model. The linear model, and consequently the sampled audio signal 130, of each time slot is here represented by a matrix, M. The matrix M comprise values corresponding to the slope k, the mean amplitude value m, and a fit quality metric, Q, of the linear model.

In an example, each time slot, Tₙ, in the interval, I, of n time slots, can be represented by a corresponding matrix Mₙ=(kₙ, mₙ, Qₙ).

The fit quality metrics, Q, of the time slots, T, may be used to identify an interval, I, or the time period P during which the sampled audio signal 130 decreases exponentially. In particular, if the fit quality metric Q indicates a poor fit (e.g., Q<0.7 on a scale of 0-1) for a majority (or, e.g., more than 20%) of time slots, T, in a consecutive sequence of time slots, it may be determined that the event 140 has not occurred. On the other hand, if a majority (e.g., at least 80%) of the time slots in a consecutive sequence of time slots have a fit quality metric, Q, indicating an accurate fit (e.g., Q>0.7), the sampled audio signal 130 may further processed to determine if the event has occurred.

Although not explicitly depicted in FIG. 4A, the interval of timeslots, I, may constitute a plurality of sub-intervals of time slots T.

The values of the mean amplitude value, m, and slope, k, of each time slot in the interval, I, or sub-interval may be used to form a (k-m) linear regression (i.e., k=c₁+m*c₀).

A quality or goodness (e.g., R²-value) of the (k-m) linear regression of the matrix data from the time slots T in the interval, I, or sub-interval, may correspond to a score value. The score may represent a likelihood of the event 140 having occurred. When a score is determined for each sub-interval of time slots T, a mean or median-like function may be used on the plurality of scores to represent a resulting score value. For example, if R²-values are determined for each (m-k) linear regression of each sub-interval, a mean or median value may be calculated from the R²-values. However, e.g., a greatest, or second to greatest R²-value may be used to represent a score.

When considering R²-values for the quality metrics, it has been established that the score is typically greater than 0.999 for simulated data. This has been observed to decrease to greater than 0.95 with minor model deviations, and further down to greater than 0.7 with added noise.

Hence, for score values above 0.7 (on a scale of 0-1, where 1 represents a perfect score) it may be determined that the event 140 has occurred (i.e., that the microphone device 100 has been tampered with).

In particular, in simulations with added noise, it has been observed that a score threshold of 0.7 may result in no false triggers for over 20,000 million 10-second-long simulated sampled audio signals 130.

In FIG. 4A, the sampled audio signal 130 and event 140 has been depicted when the event 140 forms for positive amplitude values (i.e., on the positive side of the zero state 132, i.e., DC, of the sampled audio signal). However, it is to be understood that the event 140 may equally form for negative amplitude values (i.e., on the negative side of the zero state 132). Hence, the amplitude peak and exponential decrease of the amplitude may generally be referred to as absolute amplitude peak and exponential decrease of the absolute amplitude, respectively.

FIG. 4B shows another sampled audio signal 130 comprising an event corresponding to tampering of a microphone device.

FIG. 4B largely benefits from the discussion of FIG. 4A. However, in FIG. 4B, an amplitude peak is followed directly by an exponentially decreasing amplitude. The amplitude specifically decreases in an exponential manner towards a zero state 132 of the sampled audio signal 130.

In an example, the event may comprise the absolute amplitude peak of the sampled audio signal 130 directly followed by the exponentially decreasing absolute amplitude of the sampled audio signal 130 during a time period, P.

Hence, detection of tampering of the microphone device may correspond to detection of an absolute amplitude peak followed by an exponentially decreasing absolute amplitude of the sampled audio signal 130 during a time period, P. The exponentially decreasing behavior of the sampled audio signal 130 (i.e., time period, P) may thus start directly after an amplitude peak.

FIG. 4C shows a sampled audio signal 130 from a microphone device having been tampered with at multiple instances in time. It is appreciated that FIG. 4C benefits from the discussions of FIGS. 4A and 4B.

In FIG. 4C, it is depicted that the characteristic behavior of the exponentially decreasing absolute amplitude value may take place on either side of the or zero state 132. Specifically, the event may take various forms, however, each event corresponding to tampering comprises an exponentially decreasing absolute amplitude of the sampled audio signal 130 during a time period, P.

It will be appreciated that the present invention is not limited to the embodiments shown. Several modifications and variations are thus conceivable within the scope of the invention which thus is defined by the appended claims.

1. A computer-implemented method for tampering detection of a microphone device, the microphone device comprising a microphone arranged in a cavity open to surroundings of the microphone device via a microphone hole, the method comprising:
receiving an audio signal from the microphone;
sampling the audio signal for a low frequency band by decimating the audio signal to a sampling rate;
detecting an event comprising an exponentially decreasing absolute amplitude of the sampled audio signal, wherein the exponentially decreasing absolute amplitude of the event decreases exponentially during a time period of at least one second; and
upon detecting the event, outputting a tampering detection signal.

2. The computer-implemented method according to claim 1, wherein the low frequency band comprises frequencies below 500 Hz.

3. The computer-implemented method according to claim 1, wherein the time period is 1-20 seconds.

4. The computer-implemented method according to claim 1, further comprising detecting an absolute amplitude peak of the sampled audio signal before detecting the event comprising the exponentially decreasing absolute amplitude of the sampled audio signal, wherein the absolute amplitude peak is at least an order of magnitude higher than absolute amplitudes of the sampled audio signal caused by background noise of the surroundings.

5. The computer-implemented method according to claim 4, wherein the time period starts at least one second after detecting the absolute amplitude peak.

6. The computer-implemented method according to claim 1, wherein an instantaneous rate of change of the exponentially decreasing absolute amplitude is linearly proportional to a corresponding instantaneous amplitude of the sampled audio signal.

7. The computer-implemented method according to claim 1, wherein the step of detecting the event comprises:
segmenting the sampled audio signal into a plurality of time slots; and within each time slot:
fitting a linear model to capture a local trend,
determining a mean amplitude value of the linear model,
determining a slope of the linear model, and
determining a fit quality metric of the linear model, such that each time slot is represented by a matrix comprising a mean amplitude value, a slope, and a fit quality metric.

8. The computer-implemented method according to claim 7, wherein the step of detecting the event further comprises:
determining, for a consecutive sequence of time slots, if the fit quality metrics are above a threshold value for at least a portion of the time slots in the consecutive sequence of time slots.

9. The computer-implemented method according to claim 7, wherein the step of detecting the event further comprises:
identifying an interval of time slots having a highest numerical sum of fit quality metrics in the plurality of time slots; and
determining, for the interval of time slots, a score representing a likelihood of the event having occurred in the sampled audio signal in the interval of time slots.

10. The computer-implemented method according to claim 9, wherein the score is determined based on a plurality of sub-scores, each sub-score corresponding to a respective sub-interval of time slots within the interval of time slots.

11. The computer-implemented method according to claim 9, wherein the step of detecting the event further comprises:
determining a linear regression with the slope of the linear model of each time slot in the interval of time slots as a function of the mean amplitude value the linear model of each time slot in the interval of time slots, such that, k=c₁+m*c₀, where k is the slope of the linear model in each time slot, m is the mean amplitude value of the linear model in each time slot, and c₁ and c₀ are constants.

12. The computer-implemented method according to claim 11, wherein the score is represented by a quality of fit metric of the determined linear regression k=c₁+m*c₀.

13. The computer-implemented method according to claim 11, further comprising: performing a validation step comprising:
determining if c₀ corresponds to a zero state of the sampled audio signal, and
determining if c₁ corresponds to an expected time period during which the exponentially decreasing absolute amplitude of the event decrease exponentially.

14. A non-transitory computer-readable medium storing instructions thereon which, when executed by a processor, cause the processor to carry out a method for tampering detection of a microphone device, the microphone device comprising a microphone arranged in a cavity open to surroundings of the microphone device via a microphone hole, the method comprising:
receiving an audio signal from the microphone;
sampling the audio signal for a low frequency band by decimating the audio signal to a sampling rate;
detecting an event comprising an exponentially decreasing absolute amplitude of the sampled audio signal, wherein the exponentially decreasing absolute amplitude of the event decreases exponentially during a time period of at least one second; and
upon detecting the event, outputting a tampering detection signal.

15. A system comprising:
a microphone device comprising a microphone arranged in a cavity open to surroundings of the microphone device via a microphone hole; and a processing unit configured to execute a method for tampering detection of a microphone device, the microphone device comprising a microphone arranged in a cavity open to surroundings of the microphone device via a microphone hole, the method comprising:
receiving an audio signal from the microphone;
sampling the audio signal for a low frequency band by decimating the audio signal to a sampling rate;
detecting an event comprising an exponentially decreasing absolute amplitude of the sampled audio signal, wherein the exponentially decreasing absolute amplitude of the event decreases exponentially during a time period of at least one second; and
upon detecting the event, outputting a tampering detection signal.
